(19) United States
(12) Patent Application Publication
(10) Pub. No.: US 2024/0161958 A1
(43) Pub. Date: May 16, 2024

(54) INDUCTOR, MANUFACTURING METHOD FOR INDUCTOR, ENCAPSULATION MODULE, AND MANUFACTURING METHOD FOR ENCAPSULATION MODULE

(71) Applicant: Silergy Semiconductor Technology (Hangzhou) LTD, Hangzhou (CN)

(72) Inventors: Ke Dai, Hangzhou (CN); Jian Wei, Hangzhou (CN); Jiajia Yan, Hangzhou (CN)

(21) Appl. No.: 18/386,302

(22) Filed: Nov. 2, 2023

(30) Foreign Application Priority Data
Nov. 11, 2022 (CN) 202211420564.1
Sep. 20, 2023 (CN) 202311218501.2

(51) Int. Cl. H01F 27/02; H01F 27/29; H01F 41/00; H01F 41/26

(52) U.S. Cl. CPC H01F 27/022; H01F 27/29; H01F 41/005; H01F 41/26

(57) ABSTRACT

An inductor can include at least one winding, where each winding comprises a coil body and at least two lead-out terminals being in contact with the coil body; a first encapsulation body configured to at least encapsulate part of the lead-out terminals and part of the coil body, and to expose the lead-out terminals; and where the first encapsulation body includes an insulating main material and magnetic particles dispersed in the insulating main material.

### RELATED APPLICATIONS

This application claims the benefit of Chinese Patent Application No. 202311218501.2, filed on Sep. 20, 2023, which claims the benefit of Chinese Patent Application No. 202211420564.1, filed on Nov. 11, 2022, both of which are incorporated herein by reference in their entirety.

### FIELD OF THE INVENTION

The present invention generally relates to the field of semiconductor technology, and more particularly to inductors and associated manufacturing methods.

### BACKGROUND

Inductive components, as essential energy storage and conversion devices in most electric energy conversion topology circuits, are widely used in civil, industrial, medical, aerospace, and other fields. Mainstream inductors are generally divided into wire wound assembled inductors, integrated inductors, and stacked process inductors. Wire wound assembled inductors are generally used in low frequency applications (e.g., fs<2 MHz) because of the basic requirements of structural strength and assembly tolerance of discrete components, which may not meet requirements of ultra-thin and small size.

### BRIEF DESCRIPTION OF THE DRAWINGS

FIG. 1 is a structure diagram of a first example inductor, in accordance with embodiments of the present invention.

FIG. 2 is a structure diagram of a second example inductor, in accordance with embodiments of the present invention.

FIG. 3 is a structure diagram of a third example inductor, in accordance with embodiments of the present invention.

FIG. 4 is a structure diagram of a fourth example inductor, in accordance with embodiments of the present invention.

FIG. 5 is a structure diagram of a fifth example inductor, in accordance with embodiments of the present invention.

FIG. 6 is a structure diagram of a sixth example inductor, in accordance with embodiments of the present invention.

FIGS. 7A-7D are structural diagrams of steps of an example manufacturing method of the inductor, in accordance with embodiments of the present invention.

FIG. 8 is a structural diagram of an example encapsulation module, in accordance with embodiments of the present invention.

FIGS. 9A-9E are structural diagrams of steps of an example manufacturing method of the encapsulation module, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Integrated inductors are currently a preferred inductor device with excellent characteristics, which can achieve small volume and minimal wasted space. However, due to the limitations of high tonnage pressing technology, it can be easily broken when making ultra-thin dimensions (e.g., <0.6 mm), and its characteristics are inferior to that of wire wound assembled inductors. The winding of the laminated process inductor is sintered by metallic silver paste, so its conductivity may be worse than that of the copper winding. Moreover, because it also needs high-tonnage pressing and forming, it may not be suitable to formation into ultra-thin size. In addition, the turn-to-turn insulation of the winding can be realized by the magnetic core itself, so there may be two hidden dangers: the voltage breakdown between layers of the winding is relatively easy and the silver migration can be caused by defects of the interlayer magnetic core. As such, manufacturing techniques for an inductor with relatively small size and high breakdown voltage between layers are desired.

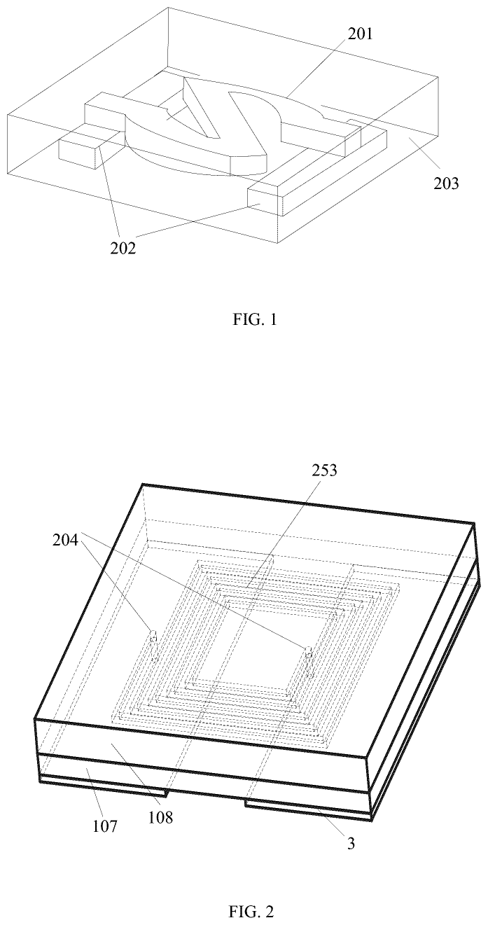

Referring now to FIG. 1, shown is a structure diagram of a first example inductor, in accordance with embodiments of the present invention. In this particular example, the inductor can include at least one winding. Here, one winding is used as an example, and each winding can include coil body 201 and at least two lead-out terminals 202 can connect to the coil body. The inductor can also include encapsulation body 203 that may encapsulate a part of the lead-out terminals 202 and a part of coil body 201. In particular embodiments, encapsulation body 203 may fully encapsulate coil body 201, such that coil body 201 is not exposed outside by encapsulation body 203. The “first” encapsulation body can include magnetic materials. For example, encapsulation body 203 can include an insulating main material and magnetic particles dispersed in the insulating main material. In particular embodiments, the magnetic particles can include at least one of carbonyl iron powder, alloy powder, micro-particle crushed ferrite powder, and amorphous nanocrystalline powder.

Referring now to FIG. 2, shown is a structure diagram of a second example inductor, in accordance with embodiments of the present invention. In this particular example, the inductor can include coil body 253, at least two lead-out terminals 204, a first encapsulation body, and pins 3. The first encapsulation body can include encapsulation bodies 107 and 108, where encapsulation body 108 can be covered on encapsulation body 107. Encapsulation bodies 107 and 108 can encapsulate coil body 253 and lead-out terminals 204, and may expose the lead-out terminals on the lower surface of the fourth encapsulation body. For example, encapsulation body 107 can at least partially encapsulate lead-out terminals 204, and encapsulation body 108 can at least partially encapsulate of coil body 253. The exposed lead-out terminals may be used for electrical connection with external circuits. In particular embodiments, the exposed lead-out terminals can connect to pins 3. In addition, encapsulation body 108 may fully encapsulate the coil body, such that the coil body is not exposed outside by encapsulation body 108. In other examples, part of the coil body can also be exposed to the outside by encapsulation body 108.

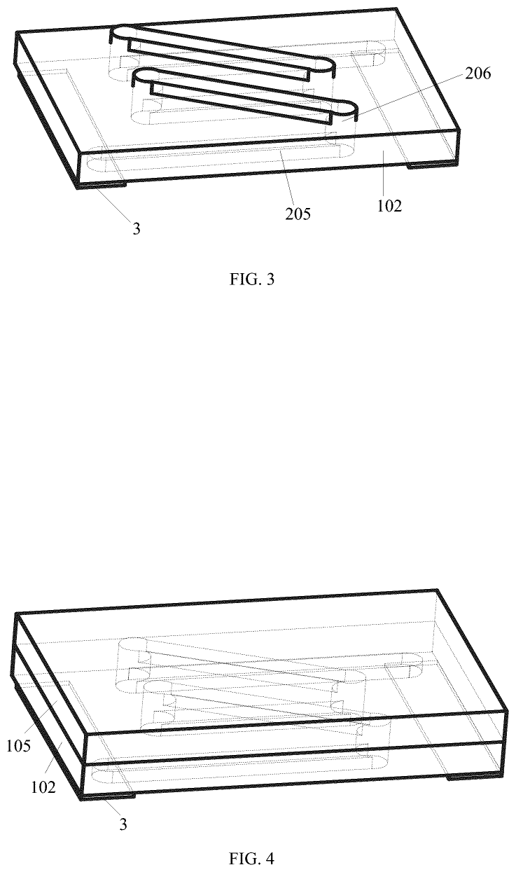

Referring now to FIG. 3, shown is a structure diagram of a third example inductor, in accordance with embodiments of the present invention. In this particular example, the inductor can include coil body 206, lead-out terminals 205, encapsulation body 102, and pins 3. For example, encapsulation body 102 can encapsulate part of the coil body, such that at least part of the coil body is exposed outside encapsulation body 102. Encapsulation body 102 can include opposite first and second surfaces, with part of the coil body being exposed on the first surface of encapsulation body 102. Encapsulation body 102 may also encapsulate the lead-out terminals and expose a lower portion of the lead-out terminals on the second surface. Pins 3 can be set on the second surface and the electrically connected to the lead-out terminals.

Referring now to FIG. 4, shown is a structure diagram of a fourth example inductor, in accordance with embodiments of the present invention. In this particular example, the inductor can include a coil body, lead-out terminals, encapsulation body 102, and pins 3, as well as encapsulation body 105. Encapsulation body 105 can cover the upper surface of encapsulation body 102, and encapsulation body 105 may encapsulate a portion of the coil body that is exposed outside encapsulation body 102. Encapsulation body 105 can include an insulating main material and magnetic particles dispersed in the main material, where the magnetic particles can include at least one of carbonyl iron powder, alloy powder, micro-particle crushed ferrite powder, and amorphous nanocrystalline powder. In other examples, the material of encapsulation body 105 can include the same magnetic material as the material of encapsulation body 102. In particular embodiments, encapsulation body 105 can be made of insulating material. For example, epoxy resin, phenolic resin, cyanate ester, polyester resin, bismaleimide, and silicone resin. The second encapsulation body can encapsulate the part of coil body exposed by the first encapsulation body to make the upper end surface of the inductor module flat.

In particular embodiments, the coil body and the lead-out terminals can be formed using an electroplating process, where the electroplating process is the electroplating step in the metal rewiring process. For example, metal redistribution layer (RDL) technology is a encapsulating technique that redistributes the I/O pins inside a chip to the surface of the chip. This technology can increase the input and output density of chips, reduce encapsulating area, and also help improve chip performance and reliability. The process flow of RDL technology can include the following steps. For substrate preparation, the chip substrate can be cleaned and removed of any unnecessary debris to ensure that the surface of the substrate is smooth, clean, and free of any residue. For photolithography production, lithography treatment can be performed on the substrate surface to produce the required circuit graphics. For metallization treatment after photolithography, the circuit patterns produced on the substrate surface can be metallized for subsequent electroplating treatment. For electroplating treatment, the surface of the substrate can be covered with a layer of metal, thus forming a conductive circuit pattern. For etching treatment after electroplating treatment, excess metal parts can be removed from the substrate surface and the required circuit pattern may be formed. Finally, deposition treatment can be utilized to deposit a protective layer on the surface of the substrate to protect the circuit pattern from damage. For example, the electroplating treatment step in RDL technology can be used to produce the coil body and lead-out terminals. For example, after photolithography, the circuit pattern produced on the surface of the substrate can be metallized for subsequent electroplating treatment. Next, the circuit pattern may be electroplated, in order to form the coil body and lead-out terminal by electroplating circuit pattern.

Referring now to FIG. 5, shown is a structure diagram of a fifth example inductor, in accordance with embodiments of the present invention. In this particular example, the inductor can also include multiple coil bodies, which may include two coil bodies 401 and 402 arranged side by side. In this examples, two coil bodies 401 and 402 arranged side by side can be encapsulated inside encapsulation body 102, and a portion of the exposed coil body may be located on the upper surface of encapsulation body 102. The lead-out terminals may be exposed on the lower surface of encapsulation body 102, and pins 3 can connect to the exposed lead-out terminals on the lower surface of encapsulation body 102.

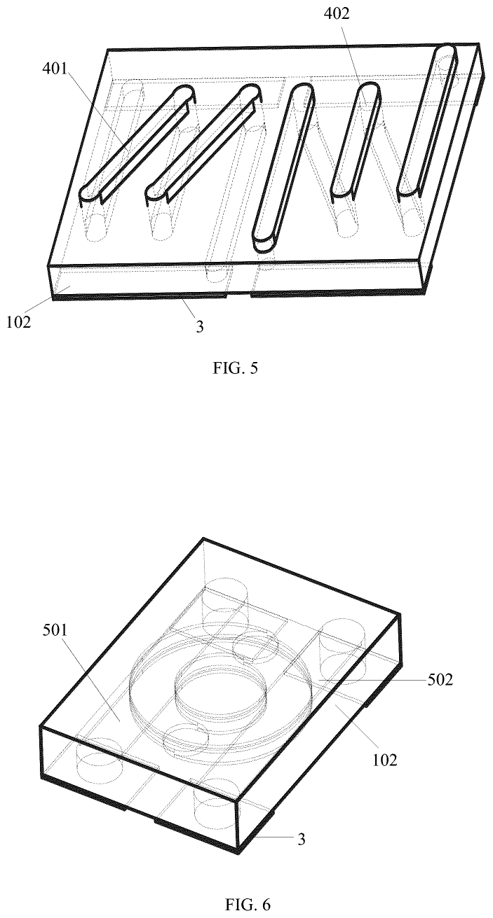

Referring now to FIG. 6, shown is a structure diagram of a sixth example inductor, in accordance with embodiments of the present invention. In this particular example, the inductor can include coil bodies 501 and 502 stacked in a longitudinal direction. For example, two coil bodies 501 and 502 stacked in a longitudinal direction can be fully encapsulated within encapsulation body 102, and the lead-out terminals may be exposed on the lower surface of encapsulation body 102. Pins 3 can connect to the lead-out terminals exposed on the lower surface of encapsulation body 102.

In other examples, as shown in FIGS. 1 and 2, the shape of the coil body can be set to square, S-shaped, or spiral, and may alternatively be set to other shapes. For example, the shape of the coil body is not limited, as long as the shape of the winding that can achieve the purpose of the invention is within the scope of protection of this application. Example manufacturing methods for inductors will also be discussed below.

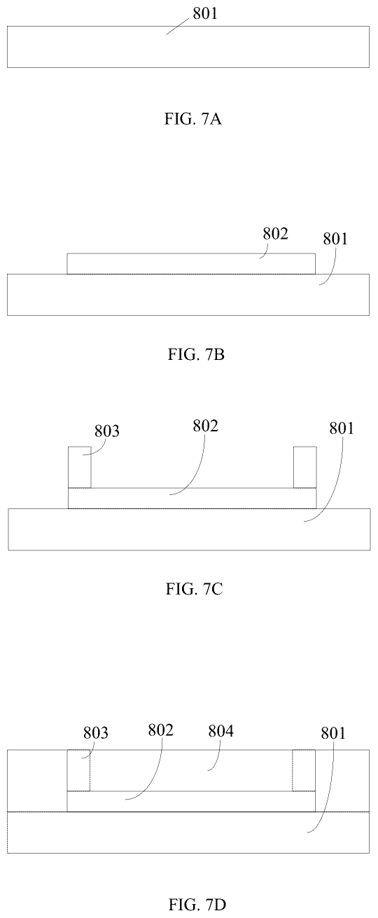

Referring now to FIGS. 7A-7D, shown are structural diagrams of steps of an example manufacturing method of the inductor, in accordance with embodiments of the present invention. As shown in FIG. 7A, substrate 801 is provided. As shown in FIG. 7B, coil body 802 may be formed on substrate 801. For example, a first layer of photoresist can be coated to the substrate, and then the first layer of photoresist may be exposed and developed to form a patterned first photoresist on the substrate, where the patterned first photoresist can include a window for subsequent formation of the coil body. A circuit pattern may be formed on the patterned first photoresist exposed substrate 801; that is, a circuit pattern can be formed at the window, and a first metal layer may be electroplated based on the circuit pattern to form the coil body.

As shown in FIG. 7C, lead-out terminals 803 can be formed on coil body 802. For example, a second layer of photoresist may be coated to the upper surface of coil body 802 and the patterned first photoresist, and then the second layer of photoresist may be exposed and developed to form a patterned second photoresist. The patterned second photoresist can include a window that subsequently forms lead-out terminals, and a second metal layer may be electroplated at the window to form lead-out terminals 803.

As shown in FIG. 7D, the remaining first and second layers of photoresist can be removed, and cover plate 804 can be utilized to encapsulate coil body 802 and lead-out terminals 803. For example, cover plate 804 can include an insulating main material and magnetic particles dispersed in the insulating main material. The magnetic particles can include at least one of carbonyl iron powder, alloy powder, micro-particle crushed ferrite powder, and amorphous nanocrystalline powder. The material of substrate 801 may be the same as that of cover plate 804. In this example, the upper end surface of the cover plate 804 may not expose coil body 802, such that coil body 802 is fully encapsulated within cover plate 804 and substrate 801.

In particular embodiments, an example manufacturing method of forming the inductor can also include forming pins that are in contact with and electrically connected to the lead-out terminals. For example, the circuit pattern formed on the substrate with patterned photoresist can include a metal copper layer or a metal aluminum layer.

In particular embodiments, before coating photoresist on the substrate, chemical mechanical polishing (CMP) may also be performed on the substrate to make the surface of the substrate flat. For example, CMP technology can be used to achieve substantial flatness in semiconductor technology manufacturing. This process is aimed at making the surface of the substrate both flat and free from scratches and impurities. CMP is a technology that combines chemical and mechanical effects. Firstly, a chemical reaction occurs between the surface material of the substrate and the oxidant catalyst in the polishing solution, generating a relatively easy to remove soft layer. Then, under the mechanical action of the abrasive and polishing pad in the polishing solution, the soft layer is removed to expose the substrate surface again, and multiple chemical reactions are carried out. This completes the polishing of the substrate surface during the alternating process of chemical and mechanical action.

In particular embodiments, using a first encapsulation body to encapsulate the coil body can include completely encapsulating the coil body in the first encapsulation body. In other examples, a part of the coil body can be encapsulated in the first encapsulation body to expose the upper surface of the coil body. In other examples, insulating materials can also be used to encapsulate the exposed part of the coil body, making the surface of the inductor structure flat. Alternatively, the same material as the first encapsulation body can be used to encapsulate the exposed part of the coil body.

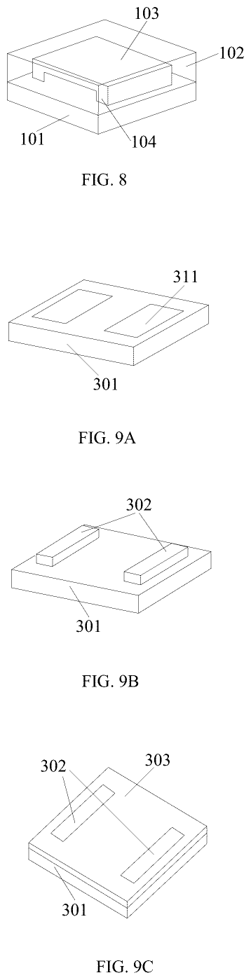

Referring now to FIG. 8, shown is a structural diagram of an example encapsulation module, in accordance with embodiments of the present invention. In this particular example, the encapsulation module can include encapsulation body 101 that encapsulates a die. The encapsulation module can also include the inductor (magnetic element) discussed above. For example, encapsulation body 101 can include opposite first and second surfaces, whereby the first surface can include an exposed patterned first metal connection structure, and the second surface can include an exposed patterned second metal connection structure electrically connected to the die for electrical connection to external circuits, and the third encapsulation body can be made of non-magnetic material. The inductor can include encapsulation body 102 that can include a third surface adjacent to the first surface. The inductor can include exposed lead-out terminals 104 of coil body, whereby the first metal connection structure and lead-out terminals 104 of the coil body are electrically connected to each other.

Furthermore, the area of the surfaces (i.e., the first and third surfaces) on which encapsulation bodies 101 and 102 come into contact with each other can be substantially the same. The material of encapsulation body 101 may be different from that of encapsulation body 102. The material of encapsulation body 102 can include magnetic components, and the material of encapsulation body 101 can be an insulating material. The material of encapsulation body 102 can include an insulating main material and magnetic particles dispersed in the insulating main material. For example the insulating main material can include at least one of epoxy resin, phenolic resin, cyanate ester, polyester resin, bismaleimide, and silicone resin. The magnetic particles can include at least one of carbonyl iron powder, alloy powder, micro-particle crushed ferrite powder, and amorphous nanocrystalline powder.

In particular embodiments, the encapsulation module can include an inductor, where the inductor can include a first encapsulation body and a winding, and the winding can include coil body 103 and lead-out terminals 104. In this example, encapsulation body 102 may fully encapsulates the coil body, such that the coil body is not exposed. The first metal connection structure and lead-out terminals 104 can connect one by one to achieve electrical connection between the die and the magnetic element. For example, the first metal connection structure and lead-out terminals 104 may be arranged parallel to each other in a vertical direction.

In particular embodiments, the coil body of winding can be arranged as a square, equivalent to a single turn magnetic structure. In other examples (see, e.g., FIG. 1), the coil body of winding can also be arranged in “S” and spiral shapes, which may be equivalent to a magnetic structure larger than 1 turn. In addition, as shown in FIG. 3, the coil body of winding can also be set as a spiral shape, without any restrictions here.

In particular embodiments, encapsulation body 102 may fully encapsulate the coil body, and in other examples, encapsulation body 102 can partially encapsulate the coil body. Encapsulation body 102 can include a fourth surface (opposite to the third surface), and the fourth surface may expose the upper surface of the coil body. Further, the fourth surface of encapsulation body 102 may not exceed the upper surface of the coil body. In this way, part of the coil body can be exposed to increase the heat dissipation of the magnetic element.

The encapsulation module provided in certain embodiments can set the first encapsulation body as the substrate and cover plate of the magnetic component. That is, the first encapsulation body may not only serve as the encapsulation layer of the magnetic element, but also as the magnetic core cover plate of the magnetic element, which can better achieve the design of small volume requirements. The magnetic element provided in certain embodiments can completely occupy the upper or lower surface of the third encapsulation body, making more reasonable use of space, and resulting in a thinner structure and smaller size of the encapsulation module.

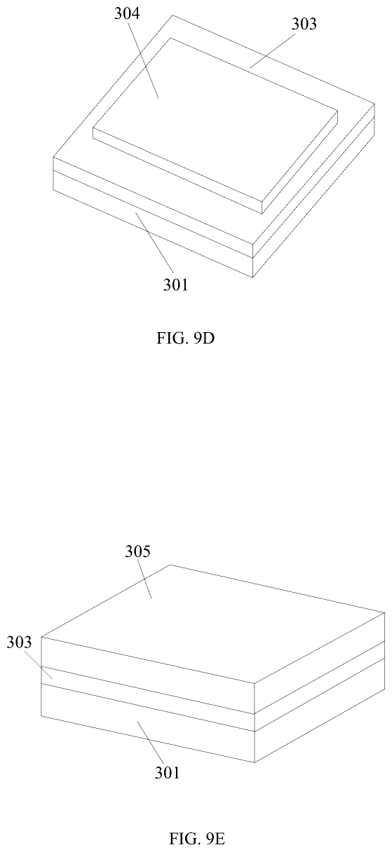

Referring now to FIGS. 9A-9E, shown are structural diagrams of steps of an example manufacturing method of the encapsulation module, in accordance with embodiments of the present invention. Forming the encapsulation module can include using a third encapsulation body to encapsulate the die, and using a first encapsulation body to encapsulate the winding, where the third encapsulation body can include opposite first and second surfaces. The first surface can include an exposed patterned first metal connection structure, and the second surface can include an exposed patterned second metal connection structure electrically connected to the die for electrical connection to external circuits. The first encapsulation body can include a third surface that is adjacent to the first surface, and the third surface can include exposed patterned lead-out terminals. The first metal connection structure and the lead-out terminals are electrically connected to each other.

As shown in FIG. 9A, encapsulation body 301 can encapsulate the die. For example, encapsulation body 301 can include opposite first and second surfaces. Exposed patterned metal connection structure 311 may be formed on the first surface, and an exposed patterned second metal connection structure can be formed on the second surface for electrical connection with external circuits. Encapsulation body 301 can be an insulating material.

As shown in FIGS. 7A-7D, the steps of using the first encapsulation body to encapsulate the winding can include forming a patterned first photoresist on a substrate, electroplating a first metal layer on the substrate exposed by the first photoresist to form a coil body, forming a patterned second photoresist on the upper surface of the coil body and the first photoresist, and electroplating a second metal layer on the coil body exposed by the second photoresist to form lead-out terminals. The first encapsulation body can include the substrate and the cover plate, both of which may be made of the same material, including an insulating main material and magnetic particles dispersed in the insulating main material. Lead-out terminals 302 can be made of copper material. In this example, lead-out terminals 302 are a square structure, but can also be of any suitable shapes and structures. Coil body 304 can be formed by an electroplating process, and the shape of coil body 304 can be set as square or “S” shaped (see, e.g., FIG. 2) or spiral. Coil body 304 can be selected as a metal material (e.g., copper material).

In other embodiments, a first encapsulation body can also be used to encapsulate the winding. The specific steps include directly encapsulating the formed winding in the first encapsulation body, where the winding can include the lead-out terminals welded to the first metal connection structure and the coil body.

Referring now to FIG. 9B, lead-out terminals 302 can be formed on first encapsulation body 301, and lead-out terminals 302 may be formed using electroplating process. Lead-out terminals 302 can connect to the corresponding pins (e.g., metal connection structure 311) of the die. Lead-out terminals 302 can be made of copper material.

As shown in FIG. 9C, encapsulation body 303 can also be formed on encapsulation body 301 to encapsulate lead-out terminals 302. Encapsulation body 303 can be flush with the upper surface of lead-out terminals 302; that is, the upper surface of metal connection structure 302 may be exposed by encapsulation body 303. As shown in FIG. 9D, coil body 304 may be formed on lead-out terminals 302 and encapsulation body 303.

As shown in FIG. 9E, encapsulation body 305 can be formed on encapsulation body 303 to encapsulate at least a portion of the coil body. For example, encapsulation body 305 can fully encapsulate the coil body, or at least expose the upper surface of the coil body for better heat dissipation. For example, the first encapsulation body can include encapsulation body 303 and encapsulation body 305. For example, the first encapsulation body can include an insulating main material and magnetic particles dispersed in the insulating main material. The magnetic particles can include at least one of carbonyl iron powder, alloy powder, microparticle broken ferrite powder, and amorphous nanocrystalline powder.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. An inductor, comprising:
a) at least one winding, wherein each winding comprises a coil body and at least two lead-out terminals being in contact with the coil body;
b) a first encapsulation body configured to at least encapsulate part of the lead-out terminals and part of the coil body, and to expose the lead-out terminals; and
c) wherein the first encapsulation body comprises an insulating main material and magnetic particles dispersed in the insulating main material.

2. The inductor of claim 1, wherein part of the coil body is exposed on the upper surface of the first encapsulation body.

3. The inductor of claim 1, wherein the coil body is fully encapsulated by the first encapsulation body.

4. The inductor of claim 1, wherein the lead-out terminals are respectively connected to an input terminal and an output terminal of the coil body.

5. The inductor of claim 1, further comprising pins located on the surface of the first encapsulation body and electrically connected to the lead-out terminals.

6. The inductor of claim 1, wherein the magnetic particles comprise at least one of carbonyl iron powder, alloy powder, micro-particle crushed ferrite powder, and amorphous nanocrystalline powder.

7. The inductor of claim 1, wherein the coil body and the lead-out terminals are formed by using an electroplating process.

8. The inductor of claim 7, wherein the electroplating process is an electroplating step in the metal redistribution process to form patterned coil body and the lead-out terminals.

9. The inductor of claim 2, further comprising a second encapsulation body, covering the first encapsulation body and being used to encapsulate the part of the coil body that is exposed to the outside of the first encapsulation body.

10. The inductor of claim 9, wherein the second encapsulation body comprises an insulating main material and magnetic particles dispersed in the main material, and the material of the second encapsulation body comprises a same magnetic particles as the material of the first encapsulation body.

11. The inductor of claim 7, wherein the second encapsulation body is made of non-magnetic material.

12. The inductor of claim 1, wherein a shape of the coil body is configured as square, S-shaped, or spiral.

13. The inductor of claim 1, wherein the inductor comprises at least two coil bodies arranged side by side.

14. The inductor of claim 1, wherein the inductor comprises at least two coil bodies stacked in a longitudinal direction.

15. A method of manufacturing inductors, the method comprising:
a) electroplating metal on a substrate to form a winding, wherein the winding comprises a coil body and lead-out terminals located below the coil body;
b) using a cover plate to at least partially encapsulate the winding, and at least exposing upper surfaces of the lead-out terminals; and
c) wherein a material of the cover plate and the substrate are the same, and the material comprises an insulating main material and magnetic particles dispersed in the main material.

16. The method of claim 15, wherein the magnetic particles comprises at least one of carbonyl iron powder, alloy powder, micro-particle crushed ferrite powder, and amorphous nanocrystalline powder.

17. The method of claim 15, wherein the forming the coil body comprises:
a) forming a patterned first photoresist on the substrate;
b) electroplating a first metal layer on the substrate exposed by the first photoresist to form a coil body;
c) forming a patterned second photoresist on the upper surface of the coil body and the first photoresist; and
d) electroplating a second metal layer on the coil body exposed by the second photoresist to form at least two lead-out terminals.

18. The method of claim 16, wherein before forming a patterned first photoresist on the substrate, further comprising performing chemical mechanical polishing on the substrate to ensure a flat surface.

19. The method of claim 16, further comprising forming pins on the upper surface of the cover plate, wherein the pins are configured to be in contact with and electrically connected the upper surface of the lead-out terminals

20. The method of claim 16, wherein an upper surface of the coil body is not exposed or at least exposed by the cover plate.
